(19) United States
(12) Patent Application Publication
(10) Pub. No.: US 2010/0313721 A1
(43) Pub. Date: Dec. 16, 2010

(54) Method for forming hemmed edges at a punch hole of a metal protective component

(76) Inventor: Xuejun CUI, Beijing (CN)

Correspondence Address: Xuejun CUI;BEIJING ZHONGYONG AUTO PARTS CO., LTD., DONGYAN VILLAGE SOUTH, LIANGXIANG, FANGSHAN DISTRICT, BEIJING, 102488, CN

(21) Appl. No.: 12/685,684

(22) Filed: Jan. 12, 2010

(30) Foreign Application Priority Data
Jun. 11, 2009 (CN) 200910086344.8

(51) Int. Cl. B26D 7/27

(52) U.S. Cl. 83/19

(57) ABSTRACT

The present invention discloses a method for forming hemmed edges at a punch hole of a metal protective component. The manufacturing process is performed by a punch assembly which comprises a pyramidal punch head and a planar surface, a planar die and a die support with disposed with a spring thereunder, wherein the pyramidal punch head of the punch assembly applies downward vertical force towards a center position of the hole, and together with a vertical upward supportive force exerted by the die support, bent edges resembling shape of flower petals are formed at the punch hole; thereafter, as the punch assembly continues to move downwards, the bent edges are bent along a planar gap above the die, and finally the bent edges are pressed to form hemmed edges which are parallel to a base of the component.

### BACKGROUND OF THE INVENTION

The present invention relates to a method for forming hemmed edges at a punch hole of a metal protective component which is especially suitable for use in components with multi-layers or a laminated layer therebetween.

Metal heat-insulating and protective components are widely applicable in modern industries. The properties of metals enable metal heat-insulating and protective components to exhibit the characteristics of high strength level and good shock-proof capability, and to be suitable for use in all weather conditions, convenient to install and replace, and durable to use. In particular, in the field of metal heat-insulating products, metal protecting covers usually have double-layer or multi-layer structures. Apart from laminating heat-insulating materials, such products attain good heat-insulation effect by air sealing. One of the many important factors that guarantees heat-insulation is to ensure the heat-insulating covers are in an air-sealed state. Therefore, hemming is not only required for edges of a product, but also for installation holes of the product.

Currently, an installation portion that is required to be punched is punched to form a plurality of bent edges resembling the shape of flower petals. The bent edges are perpendicular to the base of the heat-insulating cover. Thereafter, the perpendicular opening is mounted to an upright post in the next manufacturing process. The perpendicular edges are then pressed and flattened. Such technology divides the punching process into multiple operations and is therefore low in efficiency, complex to operate and easy to produce scraps. Therefore, the key to increase production efficiency and lower production costs is to reduce the number of manufacturing processes of the punching and hemming method to the minimum.

### BRIEF SUMMARY OF THE INVENTION

The object of the present invention is to provide a method for forming hemmed edges at a punch hole of a metal protective component which could reduce manufacturing processes and apparatus, requires only a single step to complete punching and hemming, and is applicable to different thicknesses and different number of metal layers and heat-insulating layer with a laminate therebetween.

To attain this, the method for forming hemmed edges at a punch hole of a metal protective component of the present invention is as follows:

The portion to be punched is positioned accordingly to the desired position and size. The punch assembly and the die of the punching and hemming apparatus are then assembled at corresponding positions. The apparatus may be assembled to corresponding positions of a die or to other punching machines. The punching and hemming apparatus has the following structures: the apparatus is provided with a punch assembly M1, a die M2 prepared according to the diameter of the hole to be punched, and a die support M3 disposed with a spring thereunder. The operation of the punching and hemming apparatus is as follows: First, the portion to be punched is positioned according to the desired position and size. As the punch assembly M1 moves downwards, the sharp portion of the pyramidal punch head contacts the component and then penetrates the component with the support provided by the spring of the die support M3, thereby forming bent edges resembling the shape of flower petals. The bent edges are perpendicular to the base of the heat-insulating component. Thereafter, the punch assembly M1 continues to move downwards, the die support M3 is depressed to move downwards and the bent edges start to contact the upper planar surface of the die M2. As the gap between the pyramidal punch head of the punch assembly M1 and the aperture of the die M2 is smaller than the thickness of a single layer of metal base sheet, the bent edges could only bent along a planar gap above the die M2. As the punch assembly M1 continues to move downwards, the perpendicular bent edges continues to bend until the edges are pressed and flattened to be parallel to the base of the heat-insulating component, thereby completing the punching and hemming process. The middle layer may be made of heat-insulating materials such as ceramic fiber, glass fiber, or graphite fiber. It could also be a layer of air.

The present invention is advantageous in that punching and hemming can be completed in one single manufacturing process, thereby reducing labour, capital investment for die apparatus and costs, and also increasing production efficiency. Besides, the hemmed edges formed by the present invention would not produce any scrap, thereby preventing the scrap from damaging the die, and further ensuring product quality and the durability of the die apparatus.

### BRIEF DESCRIPTION OF THE DRAWINGS

FIG. 1 shows the status of each layer of material fixed in position prior to the product manufacturing process of the present invention.

FIG. 2 shows the product as placed in the punching and hemming apparatus, wherein M1 moves downwards in a perpendicular manner, and the heat-insulating component is initially pressed.

FIG. 3 shows the status when M1 continues to move downwards to form perpendicular bent edges resembling the shape of flower petals.

FIG. 4 shows the status when M1 moves further downwards to press and flatten the bent edges and to complete the punching and hemming process.

In the figures, 10, 11 denote the metal base sheets; 12 denotes the heat-insulating material; 13 denotes the hole opened after the heat-insulating material is die-cut; 14 denotes the pyramidal portion of the punch head of M1; 15 denotes the cylinder portion of the punch head of M1; 16 denotes the planar portion of M1; 17 denotes the aperture of the die; 18 denotes the spring under M3; M1 denotes the punch assembly which comprises the punch head 14, 15 and the planer portion 16; M2 denotes the die; M3 denotes the die support disposed with the spring.

### DETAILED DESCRIPTION OF THE INVENTION

FIG. 1 illustrates the overlapping status of three layers of materials fixed into position prior to the product manufacturing process of the present invention. The metal base sheets 10, 11 are formed into the desired shape and size according to the size of the component by stamping. The middle layer is formed by die-cutting heat-insulating material 12 with a low heat transfer rate (which may be air, ceramic fiber, glass fiber, or graphite fiber). The die-cut heat-insulating material should open a hole 13 at a position where punching is to be performed. To ensure quality of the hemmed edges at the punch hole, the hole 13 should have a diameter slightly larger than the actual size of the hole to be punched. Besides, to ensure the heat-insulating material would not be displaced from the metal base sheets, inorganic adhesives may be applied to affix the heat-insulating material to the metal base sheets.

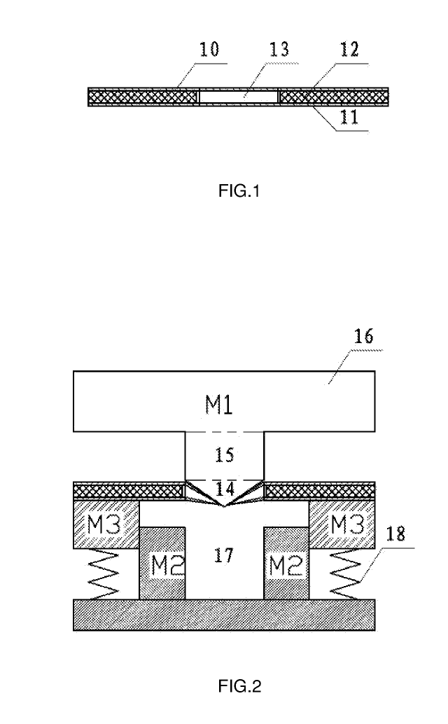

As illustrated in FIG. 2, the punching and hemming apparatus comprises a punch assembly M1 having a pyramidal punch head, a die M2 and a die support M3 having a spring. The heat-insulating material to be punched is placed into the punching and hemming apparatus according to the desired position and size. The punch assembly M1 moves downwards in a perpendicular manner. The end of the pyramidal punch head 14 of the punch assembly M1 applies downward vertical force towards a center position of the portion to be punched 13. The die support M3 applies upward vertical supportive force under the action of the spring, thereby forcing the pyramidal punch head 14 to penetrate the metal base sheets 10, 11.

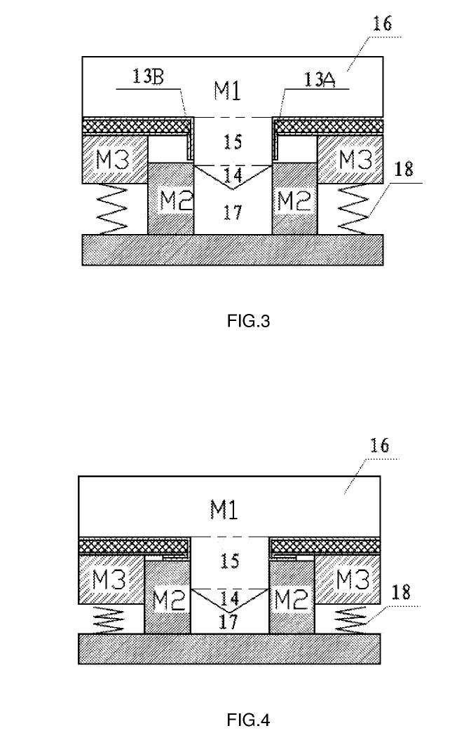

As illustrated in FIG. 3, as the punch assembly M1 continues to move downwards in a perpendicular manner, the heat-insulating component is supported by the action of the spring 18 of the die support M3, and the punch head 14, 15 penetrates the component and forms bent edges 13a, 13b resembling the shape of flower petals at the punched hole. The number of the bent edges may be determined according to the sides of the pyramidal punch head to be two, three, four or more, thereby bending two, three, four or more bent edges. The bent edges 13a, 13b lie along the cylinder 15 so that they are completely perpendicular to the base of the heat-insulating component. Thereafter, the punch head 14 enters the die M2 completely, at the same time the planar portion of the punch assembly M1 starts to contact the heat-insulating component and exert pressure towards the die support M3, thereby causing the spring to compress.

As illustrated in FIG. 4, the punch assembly M1 continues to move downwards. The apertures of the cylinder 15 and the die M2 are in close fit with each other, and the fit clearance of the cylinder 15 and the die M2 should be designed as less than the thickness of a single layer of the metal base sheet. As a result, the bent edges 13a, 13b could not enter the die M2, and could only bend along a planar gap above the die M2, and finally the bent edges 13a, 13b are pressed to form hemmed edges which are parallel to the base.

According to the above principles, it is possible to apply punching and hemming directly at the dies, or to fabricate a punching apparatus for installing onto corresponding punching apparatus.

What is claimed is:

1. A method for forming hemmed edges at a punch hole of a metal protective component, characterized in that:
a top layer of metal base sheet (10) and a bottom layer of metal base sheet (11) and a middle layer of heat-insulating material (12) are positioned according to a desired shape, size and layer configuration of the component; the metal base sheets (10, 11) and the heat-insulating material (12) are assembled to be affixed together; the heat-insulating material (12) is opened with a hole (13) after die-cutting;
a manufacturing process is performed by a punch assembly M1 which comprises a pyramidal punch head and a planar surface, a planar die M2 and a die support M3 disposed with a spring thereunder, wherein the pyramidal punch head (14, 15) of the punch assembly M1 applies downward vertical force towards a center position of the hole (13), and together with a vertical upward supportive force exerted by the die support M3, bent edges (13a, 13b) resembling shape of flower petals are formed at the punch hole; thereafter, as the punch assembly M1 continues to move downwards, the bent edges (13a, 13b) are bent along a planar gap above the die M2, and finally the bent edges (13a, 13b) are pressed to form hemmed edges which are parallel to a base of the component.

2. The method for forming hemmed edges at a punch hole of a metal protective component as in claim 1, characterized in that the middle layer is made of heat-insulating materials including ceramic fiber, glass fiber or graphite fiber, or is a layer of air.

3. The method for forming hemmed edges at a punch hole of a metal protective component as in claim 1, characterized in that the pyramidal punch head (14) of the punch assembly M1 is a multi-sided pyramid.

4. The method for forming hemmed edges at a punch hole of a metal protective component as in claim 1, characterized in that the punch assembly has a cylinder portion (15) and the die M2 has an aperture, and the cylinder portion and the aperture of the die has a gap therebetween which is smaller than thickness of a single layer of the metal base sheet.

5. The method for forming hemmed edges at a punch hole of a metal protective component as in claim 1, characterized in that the hole (13) has a size which is larger than that of the punch hole.

6. The method for forming hemmed edges at a punch hole of a metal protective component as in any of the claims 1-5, characterized in that the punch assembly M1, the planar die M2 and the die support M3 disposed with a spring thereunder form a punching and hemming apparatus which is installed onto corresponding punching apparatus.

7. The method for forming hemmed edges at a punch hole of a metal protective component as in any of the claims 1-5, characterized in that the hemmed edges are directly applied to a desired mold.

8. The method for forming hemmed edges at a punch hole of a metal protective component as in claim 6, characterized in that the punching and hemming apparatus is fabricated separately for installing onto corresponding punching apparatus to form an apparatus specialized for punching and hemming.
